(19) United States
(12) Patent Application Publication
(10) Pub. No.: US 2019/0010677 A1
(43) Pub. Date: Jan. 10, 2019

(54) BUCKET LINK HAVING SAFETY UNIT FOR USE AS CRANE

(71) Applicant: KUMSUNG ENGINEERING CO., LTD., Dangjin-si (KR)

(72) Inventors: Yun Kuk HWANG, Dangjin-si (KR); Tae Hyuck SONG, Gumi-si (KR)

(21) Appl. No.: 16/020,218

(22) Filed: Jun. 27, 2018

(30) Foreign Application Priority Data
Jul. 4, 2017 (KR) 10-2017-0085112

(51) Int. Cl. E02F 3/96; B66C 1/34

(52) U.S. Cl. CPC E02F 3/964; B66C 1/34

(57) ABSTRACT

Disclosed herein is a bucket link having a safety unit for use as a crane. The bucket link includes: a bucket link body; a crane hook provided on one side of the bucket link body in a hook shape, and configured such that a wire is hooked thereinto during use of a crane; and the safety unit for use as a crane configured to prevent the wire from being accidentally separated from the crane hook by blocking the entrance of the crane hook when the wire is hooked into the crane hook.

### BACKGROUND

### 1. Technical Field

The present invention relates generally to a bucket link having a safety unit for use as a crane, and more specifically to a bucket link having a safety unit for use as a crane, which is capable of preventing a safety-related accident from occurring due to the accidental separation of a wire from a crane hook during use as a crane.

### 2. Description of the Related Art

An excavator is a construction machine which performs excavation work for digging earth, loading work for carrying earth and sand, crushing work for dismantling a building, and ground preparation work for arranging a ground in civil engineering, construction, and construction sites.

Such a machine is called an excavator or poclain in Korea. The excavator is a common English notation, and the poclain is a brand name of a French company for an excavator.

Accordingly, although it is desirable to call such a machine an excavator, it is often called a poclain, and the excavator and the poclain are used together in Korea. In the following, such a machine will be called an excavator.

An excavator includes an undercarriage configured to move equipment, an upper revolving body configured to be mounted on the undercarriage and to rotate around 360 degrees, and a boom configured to be coupled to the upper revolving body.

Such excavators can be classified into caterpillar-type crawler excavators and tire-type wheel excavators according to the traveling method of their undercarriage.

Crawler excavators ranging from 1 ton to 100 or larger tons are more widely used in work sites due to their stable operation and high work efficiency.

Wheel excavators are less stable than crawler excavators due to their tire supporting method, but can run on roads, so that they can move between work sites without a trailer and are mainly used in work sites where work and movement are frequently performed.

Such an excavator may be equipped with an appropriate attachment depending on the condition of the earth and rock, the type of work, and the application.

Attachments chiefly used for excavators include buckets for performing general excavation and moving earth and sand, breakers for crushing hard grounds and rocks, and crushers for dismantling and crushing buildings.

Meanwhile, an excavator also serves as a crane. In this case, a bucket is removed, and a wire is hooked into a crane ring formed on a bucket link and then used.

However, when a wire is simply hooked into the crane ring of the bucket link, a problem arises in that a safety-related accident occurs due to the accidental separation of the wire.

That is, when a wire is simply hooked into a crane ring, the wire may be separated from the crane ring due to the characteristic of the wire being straightened in the form of a straight line when the wire is subjected to force and the tension of the wire increases. Accordingly, there is a need for the development of technology for overcoming the problem in that the above case may lead to a significant safety-related accident.

### PRIOR ART DOCUMENTS

### Patent Documents

(Patent Document 1) Korean Patent Application No. 10-1995-0056242

(Patent Document 2) Korean Patent Application No. 10-2004-0087907

(Patent Document 3) Korean Patent Application No. 10-2009-0064321 (Patent Document 4) Korean Patent Application No. 10-2010-0096532

### SUMMARY

An object of the present invention is to provide a bucket link having a safety unit for use as a crane, which is capable of preventing a safety-related accident from occurring due to the accidental separation of a wire from a crane hook during use as a crane.

According to an aspect of the present invention, there is provided a bucket link having a safety unit for use as a crane, the bucket link including: a bucket link body; a crane hook provided on one side of the bucket link body in a hook shape, and configured such that a wire is hooked thereinto during use of a crane; and the safety unit for use as a crane configured to prevent the wire from being accidentally separated from the crane hook by blocking the entrance of the crane hook when the wire is hooked into the crane hook.

The safety unit for use as a crane may include: a locking unit configured to be movably coupled to the bucket link body in order to selectively approach and move away from the entrance of crane hook; and a unit driving unit configured to be provided in the bucket link body, to be coupled to the locking unit, and to, when the wire is hooked into the crane hook, drive the locking unit so that the locking unit locks the entrance of crane hook by approaching and blocking the entrance of the crane hook.

The unit driving unit may be rotatably mounted inside the bucket link body with one end thereof coupled to the locking unit, and may include a bucket mounting link configured to be rotatable by a rotating shaft, and a bucket mounting cylinder configured to be connected to the bucket mounting link and to rotate the bucket mounting link.

The locking unit may include: a first locking plate disposed one side of the crane hook; a second locking plate disposed opposite to the first locking plate with the crane hook disposed therebetween; and a connection rod configured to couple the first locking plate and the second locking plate.

A base support may be provided on the bottom of the crane hook; and each of the first locking plate and the second locking plate may include: a plate body; and a triangular head formed at one end of the plate body.

The bucket link may further include: an input unit configured to input signals used to operate the locking unit; and a controller configured to control the operation of the unit driving unit based on the input signals of the input unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the structure of an excavator according to a first embodiment of the present invention;

FIG. 2 is a view showing the structure of a bucket link having a safety unit for use as a crane which is applied to the excavator shown in FIG. 1;

FIGS. 3 and 4 are views showing the operation of the safety unit for use as a crane with emphasis;

FIGS. 5 to 7 are views showing a process in which a wire is hooked into a crane hook and then the safety unit for use as a crane is operated in a stepwise manner;

FIG. 8 is a block diagram showing the control of the excavator shown in FIG. 1;

FIGS. 9 and 10 are views showing the structure of an important portion of a bucket link according to a second embodiment of the present invention, which show a process in which a safety unit for use as a crane operates in a stepwise manner; and

FIG. 11 is a block diagram showing the control of FIG. 9.

### DETAILED DESCRIPTION

Embodiments of the present invention will be described in detail below with reference to the accompanying drawings so that a person having ordinary knowledge in the art to which the present invention pertains can easily practice the present invention.

However, the following description of the present invention presents merely embodiments intended to provide structural and functional descriptions. Accordingly, the scope of the present invention should not be construed as being limited by the described embodiments.

For example, embodiments may be subjected to various modifications, and may have various forms. Accordingly, the scope of the present invention should be construed as encompassing equivalents which can implement the technical spirit of the present invention.

Furthermore, the object or effect presented by the present specification does not require that each embodiment have the object or effect or have only the object or effect, and thus the scope of the present invention should not be construed as being limited by the object or effect.

In the present specification, embodiments are provided merely to make the disclosure of the present disclosure complete and to fully convey the scope of the present invention to a person having ordinary knowledge in the art to which the present invention pertains. The present invention is defined only by the scope of the attached claims.

Therefore, in some embodiments, a well-known component, operation, and/or technology will not be described in detail in order to prevent the present disclosure from being obscurely interpreted.

Meanwhile, the meanings of the terms used herein are not limited to dictionary meanings, and should be understood, as follows:

It should be understood that when a component is described being “connected to” or “coupled to” another component, the former component may be connected or coupled directly to the latter component or may be connected or coupled to the latter component with a third component intervening therebetween. In contrast, it should be understood that when a component is described as being “connected directly to” or “coupled directly to” another component, the former component may be connected or coupled to the latter component without a third component intervening therebetween. Meanwhile, the same principle should be applied to other expressions, i.e., “between” and “immediately between,” “adjacent to” and “neighboring,” etc., which describe relationships between components.

A singular expression should be understood to include a plural expression, unless clearly expressed otherwise in the context. The terms, such as “include” or “have”, should be understood to indicate the presence of one or more features, numbers, steps, operations, components, parts, or combinations thereof, but should not be understood to exclude the presence or possible addition of one or more other features, numbers, steps, operations, components, parts, or combination thereof.

Unless otherwise defined, all the terms used herein have the same meanings as being understood by those having ordinary knowledge in the technical field to which the present invention pertains.

The terms commonly used and defined in dictionaries should be interpreted as having meanings identical to those specified in the context of related technology. Unless definitely defined therein, the terms should not be interpreted as having ideal or excessively formative meanings.

The embodiments of the present invention will be described in detail below with reference to the accompanying drawings. Throughout the descriptions of the embodiments, the same reference symbol is assigned to the same components. In some cases, a description of the same reference symbol will be omitted.

### First Embodiment

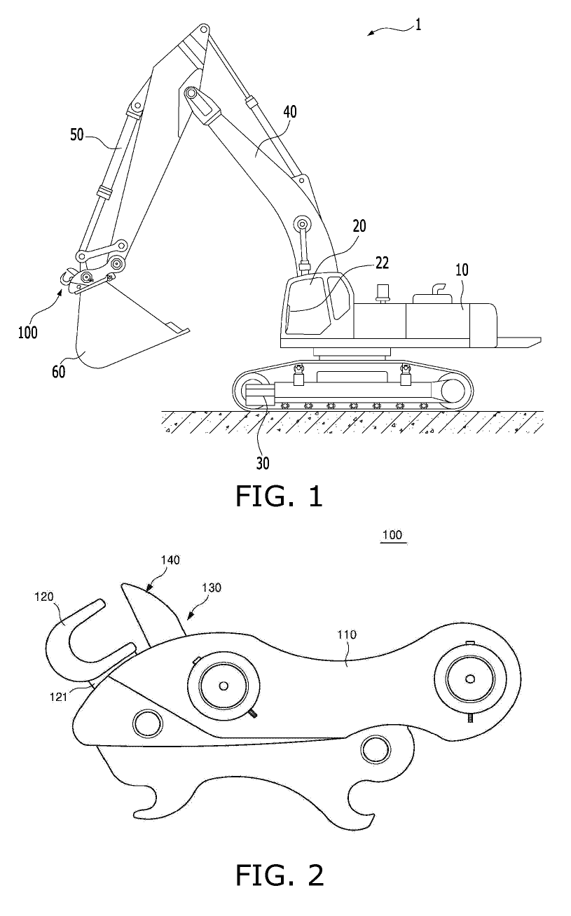

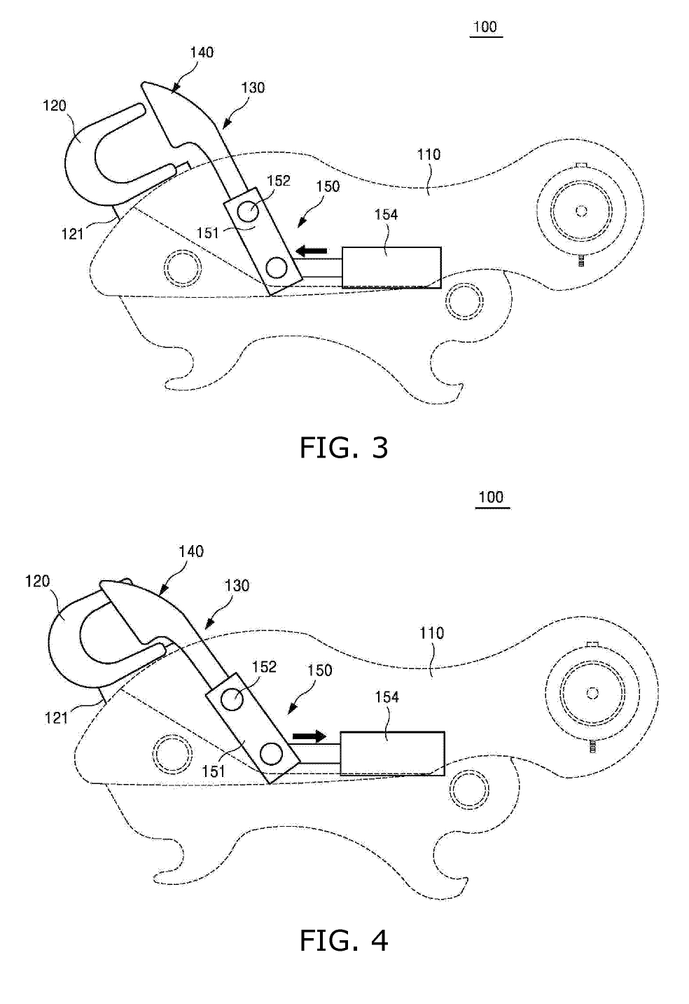

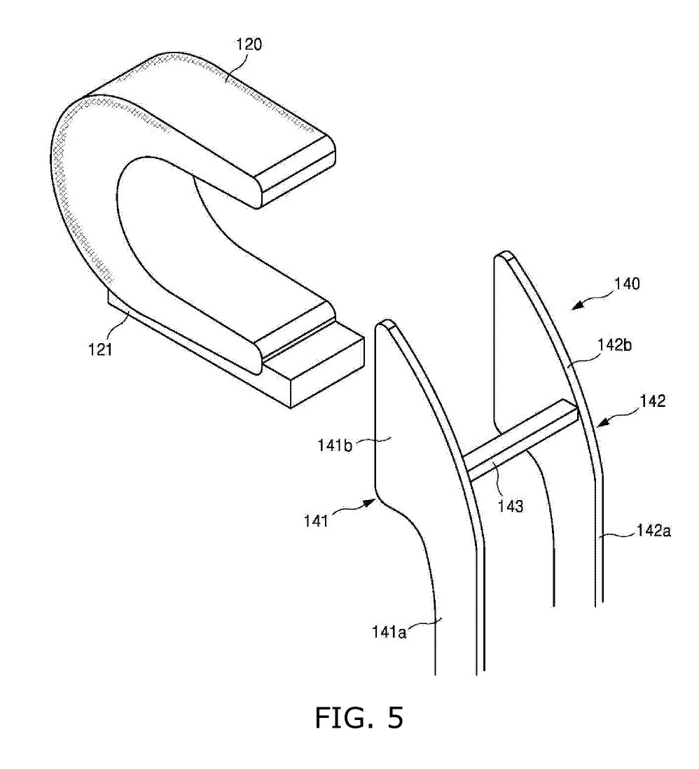

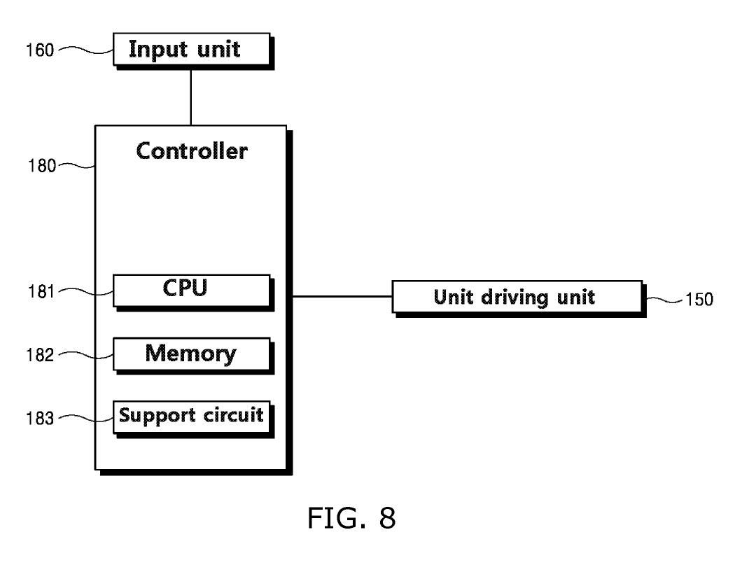

FIG. 1 is a view showing the structure of an excavator according to a first embodiment of the present invention, FIG. 2 is a view showing the structure of a bucket link having a safety unit for use as a crane which is applied to the excavator shown in FIG. 1, FIGS. 3 and 4 are views showing the operation of the safety unit for use as a crane with emphasis, FIGS. 5 to 7 are views showing a process in which a wire is hooked into a crane hook and then the safety unit for use as a crane is operated in a stepwise manner, and FIG. 8 is a block diagram showing the control of the excavator shown in FIG. 1.

Referring to these drawings, the present invention is intended to prevent a safety-related accident from occurring due to the accidental separation of a wire from a crane hook 120 during use as a crane, and includes a bucket link 100 having a safety unit 130 for use as a crane.

It will be apparent that the scope of the present invention encompasses an excavator 10 including the bucket link 100 having the safety unit 130 for use as a crane.

The excavator 10 according to the present invention will be described with reference to FIG. 1. The excavator 10 includes an undercarriage 30 configured to move equipment, an upper revolving body 10 configured to be mounted on the undercarriage 30 and to rotate around 360 degrees, and a boom 40 configured to be coupled to the upper revolving body 10.

In the present embodiment, the undercarriage 30 is a caterpillar-type undercarriage. However, a tire-type wheel method may be applied thereto, which is all encompassed in the scope of the present invention.

A cab 20 is provided in the upper revolving body 10, and a control panel 22 is provided in the cab 20. The traveling of the undercarriage 30, the rotation of the upper revolving body 10, and the operation of the boom 40 may be performed via the control panel 22.

The bucket 60 configured to perform general excavation and the transportation of soil is provided at one end of the boom 40.

Furthermore, the bucket link 100 is provided between the boom 40 and the bucket 60. The bucket link 100 functions to couple the bucket 60 to the boom 40, and may be used when a crane function is performed.

In other words, the crane hook 120 is provided on the bucket link 100. A base support 121 is provided on the bottom of the crane hook 120, and is coupled to the bucket link body 110.

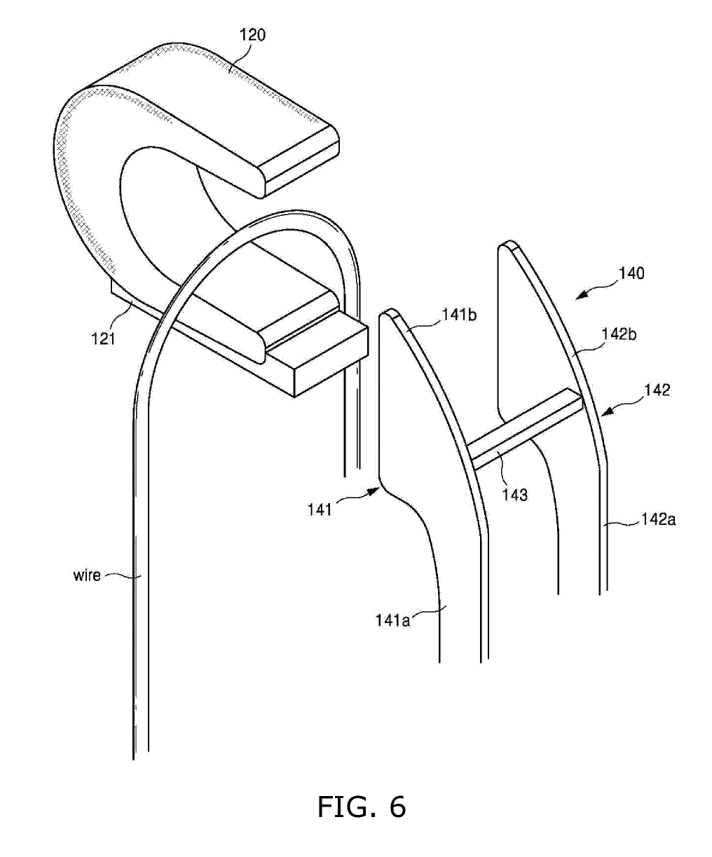

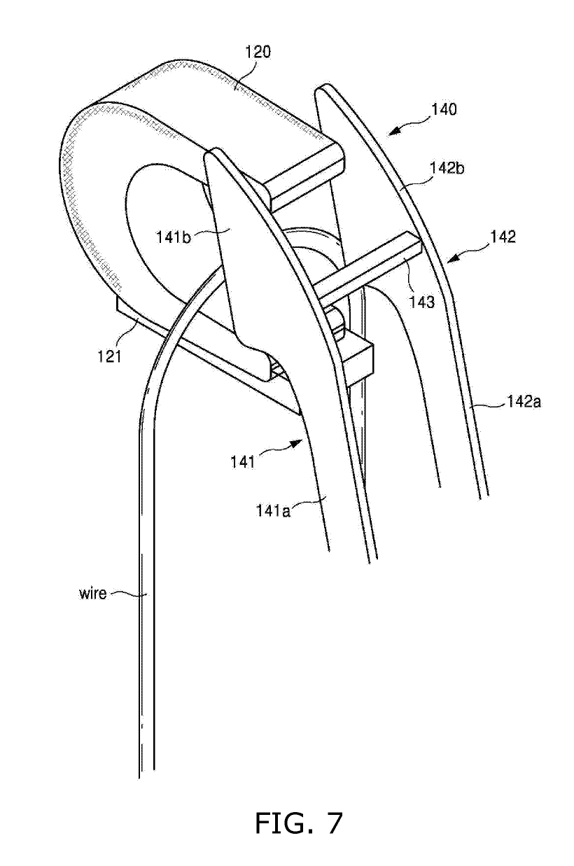

As shown in FIGS. 6 and 7, a wire is hooked into the crane hook 120, and is then used. When a crane function is performed as described above, the bucket 60 may be separated from the bucket link 100, and a wire may be hooked into the crane hook 120 of the bucket link 100 and then used.

Meanwhile, when a wire is simply hooked into the crane hook 120 and then used as described above, the wire may be separated from the crane hook 120 due to the characteristic of the wire being straightened in the form of a straight line when the wire is subjected to force and the tension of the wire increases. In this case, a significant safety-related accident may occur.

Accordingly, in the case of the present invention, the safety unit 130 for use as a crane is applied in order to prevent a safety-related accident.

When the wire is hooked into the crane hook 120, as shown in FIG. 6, the safety unit 130 for use as a crane blocks the entrance of the crane hook 120, thereby functioning to prevent the wire from being separated from the crane hook 120, as shown in FIG. 7.

When the entrance of the crane hook 120 is blocked, as shown in FIG. 7, the wire is prevented from being separated from the crane hook 120 even when the wire is subjected to force, the tension of the wire increases and the wire is straightened in the form of a straight line. Accordingly, a safety-related accident can be prevented from occurring due to the fall of the wire or an object hanging on the wire.

The safety unit 130 for use as a crane includes a locking unit 140, and a unit driving unit 150 configured to be coupled to the locking unit 140 and to drive the locking unit 140.

The locking unit 140 is a structure configured to be movably coupled to the bucket link body 110 in order to selectively approach and move away from the entrance of crane hook 120. Since the locking unit 140 needs to block the entrance of the crane hook 120, as shown in FIG. 7, the locking unit 140 is made of a metal having excellent rigidity and a predetermined weight.

The locking unit 140 may include a first locking plate 141 disposed one side of the crane hook 120, a second locking plate 142 disposed opposite to the first locking plate 141 with the crane hook 120 disposed therebetween, and a connection rod 143 configured to couple the first locking plate 141 and the second locking plate 142.

Each of the first locking plate 141 and the second locking plate 142 may include a plate body 141a or 142a, and a triangular head 141b or 142b formed at one end of the plate body 141a or 142a.

Since the triangular head 141b or 142b is formed at one end of the plate body 141a or 142a, a depressed portion is formed between the triangular head 141b or 142b and the plate body 141a or 142a. Due to the depressed portion, even when the locking unit 140 is rotated from the state of FIG. 6 to the state of FIG. 7, the locking unit 140 is not constrained by an adjacent structure.

The unit driving unit 150 is a drive device configured to be provided in the bucket link body 110 and to be coupled to the locking unit 140. When the wire is hooked into the crane hook 120, the unit driving unit 150 functions to drive the locking unit 140 so that the locking unit 140 can lock the entrance of crane hook 120 by approaching and then blocking the entrance of the crane hook 120.

The unit driving unit 150 is rotatably mounted inside the bucket link body 110 with one end thereof coupled to the locking unit 140. The unit driving unit 150 may include a bucket mounting link 151 configured to be rotatably by a rotating shaft 152, and a bucket mounting cylinder 154 configured to be connected to the bucket mounting link 151 and to rotate the bucket mounting link 151.

Meanwhile, the present invention further includes an input unit 160 and a controller 180. The input unit 160 inputs signals used to operate the locking unit 140. The input unit 160 may be applied to the control panel 22 in the excavator 1 of FIG. 1.

Furthermore, the controller 180 controls the operation of the unit driving unit 150 based on the input signals of the input unit 160. In other words, when the wire is hooked into the crane hook 120, as shown in FIG. 6, the wire is prevented from being separated from the crane hook 120 by blocking the entrance of crane hook 120 with the locking unit 140, as shown in FIG. 7.

The controller 180 may include a central processing unit (CPU) 181, memory 182, and a support circuit 183.

In the present embodiment, the CPU 181 may be one of various computer processors industrially applicable to control the operation of the unit driving unit 150 based on the input signals of the input unit 160.

The memory 182 is coupled to the CPU 181. The memory 182 is a computer-readable storage medium, and may be locally or remotely installed. The memory 182 may be at least one or more pieces of memory easily available, such as random access memory (RAM), read-only memory (ROM), a floppy disk, a hard disk, or any digital storage form.

The support circuit 183 is combined with the CPU 181, and supports the typical operation of a processor. The support circuit 183 may include a cache, a power supply, a clock circuit, input/output circuits, and a subsystem.

In the present embodiment, the controller 180 controls the operation of the unit driving unit 150 based on the input signals of the input unit 160. In this case, a series of processes by which the controller 180 controls the operation of the unit driving unit 150 based on the input signals of the input unit 160, etc. may be stored in the memory 182. Typically, a software routine may be stored in the memory 182. The software routine is also stored or executed by another CPU (not shown).

Although the processes according to the present invention are described as being executed by the software routine, at least part of the processes according to the present invention may be executed by hardware. As described above, the processes according to the present invention may be implemented by software running on a computer system, may be implemented by hardware, such as an integrated circuit, or may be implemented by the combination of software and hardware.

According to this configuration, the wire is hooked into the crane hook 120 from the basic state of FIG. 5, as shown in FIG. 6, and then the entrance of the crane hook 120 is blocked with the locking unit 140, as shown in FIG. 7. In this case, even when the wire is subjected to force, the tension of the wire increases and the wire is straightened in the form of a straight line, the wire is not separated from the crane hook 120.

Accordingly, a safety-related accident can be prevented from occurring due to the fall of the wire or an object hanging on the wire.

According to the present embodiment having the above-described structure and operation, a safety-related accident can be prevented from occurring due to the accidental separation of the wire from the crane hook during use as a crane.

### Second Embodiment

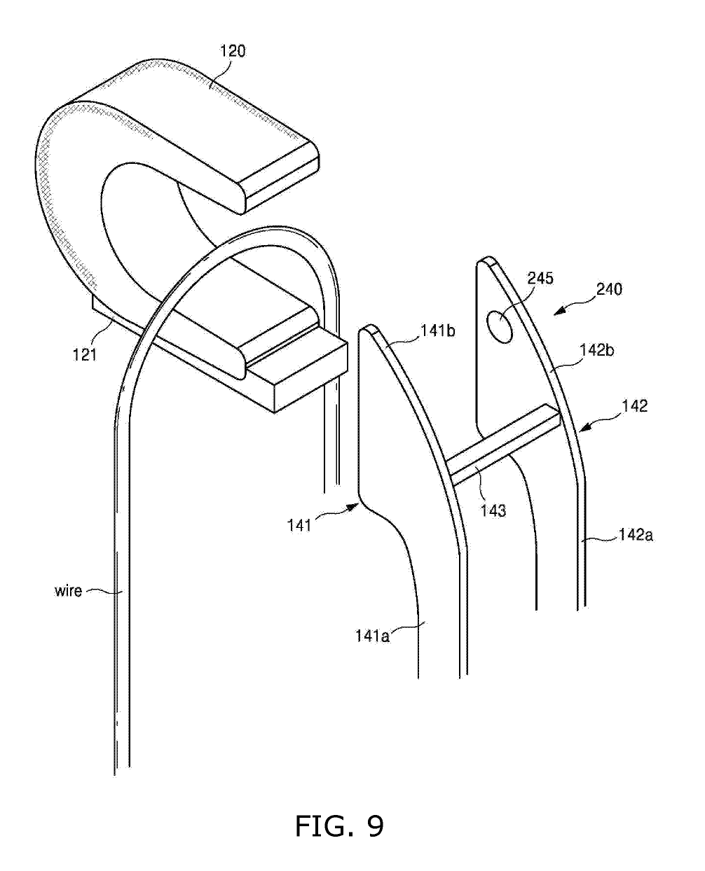

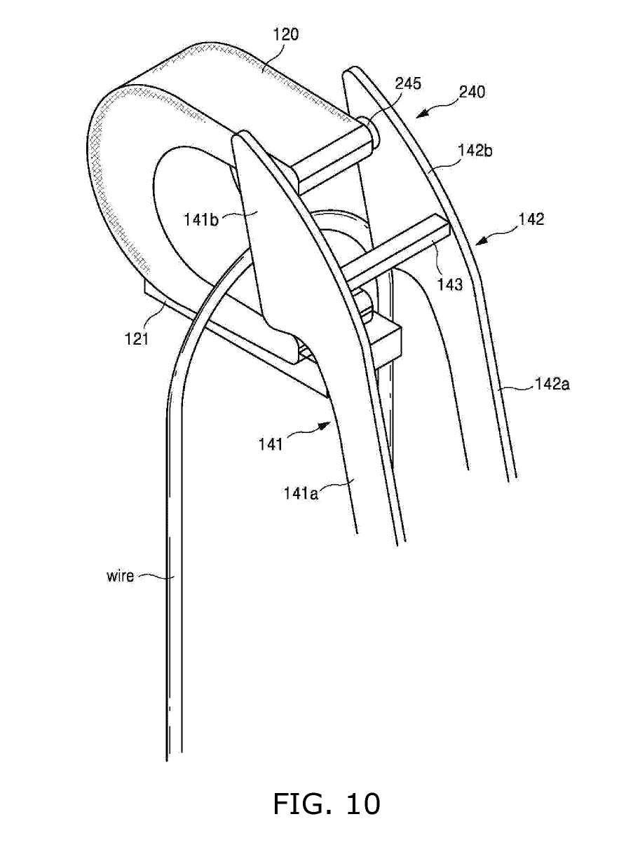

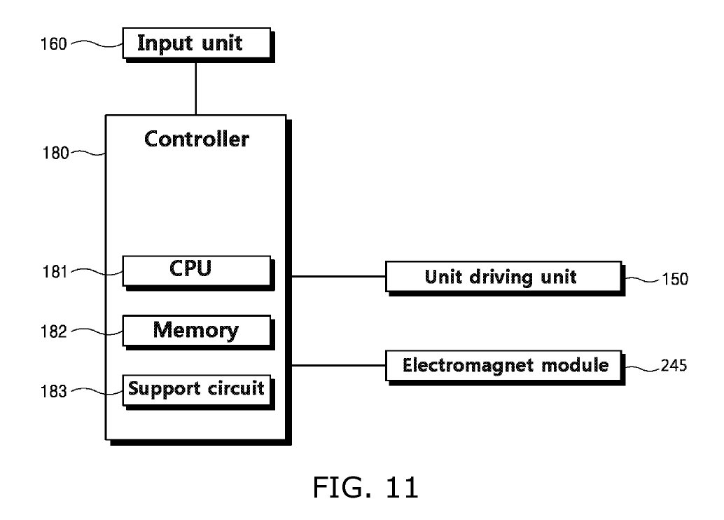

FIGS. 9 and 10 are views showing the structure of an important portion of a bucket link according to a second embodiment of the present invention, which show a process in which a safety unit for use as a crane operates in a stepwise manner. FIG. 11 is a block diagram showing the control of FIG. 9.

Referring to these drawings, in the present embodiment, in order to prevent a safety-related accident from occurring, a wire may be hooked into a crane hook 120, as shown in FIG. 9, and then the entrance of crane hook 120 may be blocked with a locking unit 240, as shown in FIG. 10.

The locking unit 240 may also include a first locking plate 141 disposed on one side of the crane hook 120, a second locking plate 142 disposed opposite to the first locking plate 141 with the crane hook 120 disposed therebetween, and a connection rod 143 configured to couple the first locking plate 141 and the second locking plate 142.

Meanwhile, in the structure, electromagnet modules 245 are provided on the insides of the first locking plate 141 and the second locking plate 142 constituting parts of the locking unit 240. The electromagnet modules 245 may be controlled by a controller 280.

In greater detail, during a process in which a wire is hooked into the crane hook 120, as shown in FIG. 9, and then the entrance of crane hook 120 is blocked with the locking unit 240, as shown in FIG. 10, power is applied to the electromagnet modules 245 by the controller 280, and thus the electromagnet modules 245 are magnetically attached to the crane hook 120, thereby supporting the operation of the locking unit 240 in a twofold manner.

According to the present embodiment, a safety-related accident can be prevented from occurring due to the accidental separation of the wire from the crane hook 120 during use as a crane.

According to the present invention, a safety-related accident can be prevented from occurring due to the accidental separation of the wire from the crane hook during use as a crane.

It will be apparent to a person having ordinary knowledge in the art to which the present invention pertains that the present invention is not limited to the described embodiments but various modifications and alterations may be made without departing from the spirit and scope of the present invention. Therefore, such modifications and alterations are considered to fall within the claims of the present invention.

What is claimed is:

1. A bucket link having a safety unit for use as a crane, the bucket link comprising:
a bucket link body;
a crane hook provided on one side of the bucket link body in a hook shape, and configured such that a wire is hooked thereinto during use of a crane; and
the safety unit for use as a crane configured to prevent the wire from being accidentally separated from the crane hook by blocking an entrance of the crane hook when the wire is hooked into the crane hook;
wherein the safety unit for use as a crane comprises:
a locking unit configured to be movably coupled to the bucket link body in order to selectively approach and move away from the entrance of crane hook; and
a unit driving unit configured to be provided in the bucket link body, to be coupled to the locking unit, and to, when the wire is hooked into the crane hook, drive the locking unit so that the locking unit locks the entrance of crane hook by approaching and blocking the entrance of the crane hook; and
wherein the locking unit comprises:
a first locking plate disposed one side of the crane hook;
a second locking plate disposed opposite to the first locking plate with the crane hook disposed therebetween; and
a connection rod configured to couple the first locking plate and the second locking plate.

2. The bucket link of claim 1, wherein:
a base support is provided on a bottom of the crane hook; and
each of the first locking plate and the second locking plate comprises:
a plate body; and
a triangular head formed at one end of the plate body.
